(19) United States
(12) Patent Application Publication
(10) Pub. No.: US 2026/0242645 A1
(43) Pub. Date: Aug. 20, 2026

(54) Liquid, One Component, Moisture Curable Polyurethane for Bonding Untreated Metals

(71) Applicant: Henkel AG & Co. KGaA, Duesseldorf (DE)

(72) Inventors: Yingjie Li, Batavia, IL (US); Shuhui Qin, Palatine, IL (US)

(21) Appl. No.: 19/641,705

(22) Filed: Apr. 8, 2026

Related U.S. Application Data
(63) Continuation of application No. PCT/US2024/050412, filed on Oct. 9, 2024.
(60) Provisional application No. 63/590,488, filed on Oct. 16, 2023.

(51) Int. Cl. C09J 175/08; C08G 18/08; C08G 18/10; C08G 18/20; C08G 18/48; C08G 18/77; C08K 3/013; C08K 5/5419; C09J 5/00

(52) U.S. Cl. CPC C09J 175/08; C08G 18/0838; C08G 18/10; C08G 18/4808; C08G 18/778; C08K 3/013; C08K 5/5419; C09J 5/00; C08G 18/2018; C09J 2301/306; C09J 2400/166; C09J 2400/283; C09J 2475/00; C09J 2493/00

(57) ABSTRACT

Disclosed is a one component, liquid, moisture curable polyurethane adhesive composition comprising a mixture including at least one isocyanate functional prepolymer; one of a) a silane compound and a tackifier or b) a silicone oligomer and optionally a tackifier; and optionally additives. The adhesive composition has enhanced bond strength to metals such as aluminum compared to currently available adhesives. The composition finds special use in panel lamination applications.

### TECHNICAL FIELD

This disclosure relates generally to liquid, one component, moisture curable polyurethane adhesive compositions and more particularly to such compositions having enhanced adhesion to metal components, particularly aluminum components. The disclosure also relates to a method for improving bond strength of liquid, one component, moisture curable polyurethane adhesive compositions to aluminum substrates, in particular mill grade aluminum substrates, and to a method of bonding composite structures comprising aluminum components using liquid, one component, moisture curable polyurethane adhesive compositions.

### BACKGROUND OF THE INVENTION

This section provides background information which is not necessarily prior art to the inventive concepts associated with the present disclosure.

Composite structures are widely used to make vehicles in the transportation field. Examples of such composite structures include commercial trailers, train cars, aircraft components, recreational vehicles, boats and automobiles. One conventional composite structure comprises a welded aluminum frame having a polymer skin bonded to one surface, a wood skin bonded to the opposing surface and foam between the polymer and wood skins. Curable polyurethane adhesives are typically used to bond the polymer skin to the aluminum frame and the wood skin to the aluminum frame.

Hot melt adhesives have been used as one composite bonding adhesive. Hot melt adhesives are solid at room temperature but, upon application of heat, they melt to a liquid or fluid state in which form they are applied to a substrate. On cooling, the adhesive regains its solid form. One class of hot melt adhesives are thermoplastic hot melt adhesives. Another class of hot melt adhesives are reactive polyurethane hot melt adhesives that start out as thermoplastic materials but when exposed to appropriate conditions crosslink and cure to an irreversibly solid form. However, hot melt adhesives require specialized equipment to heat and maintain the adhesive in molten form as well as specialized application equipment. Such equipment is not available in all manufacturing locations. Hot melt adhesives solidify quickly after application, limiting the ability to reposition components after application. Further, once heated the adhesives will increase in viscosity to an unusable level and thus have a limited pot life during which they can be used.

Another type of polyurethane based adhesive is the one component, moisture curable polyurethane adhesives that are liquid at room temperature. Their liquid form allows ease of application using conventional equipment without the complicated heating equipment needed for hot melt adhesives. They can also be formulated to cure more slowly and allow repositioning of components for some time after application. One component, moisture curable polyurethane adhesives are generally based on isocyanate containing polyurethane prepolymers. The adhesives are stored under conditions that exclude moisture. When exposed to moisture isocyanate moieties on the prepolymers irreversibly crosslink to form a cured thermoset reaction product.

Good adhesion of the polyurethane adhesive to each of the composite components is desirable to add strength to the composite structure. Ideally, the adhesive bonding strength will be greater than some, or all, of the materials it is bonded to. Additionally, water can infiltrate into a bonded composite structure. The adhesive should retain as much of the initial bond strength as possible during and after exposure to water.

Currently, manufacturers use a multi-step process to form composite structures. In a first step the metallic frame is cleaned to remove oil, grease and dirt. Next the frame is exposed to conversion coating chemicals in a bath or spray application, rinsed with water and dried. The conversion coated frame is now ready for application of adhesive and assembly into a composite structure. This process requires multiple large tanks of chemicals, lifting and drying equipment and substantial space. In a different multi step process, the metallic frame is cleaned to remove oil, grease and dirt. Next the frame is hand wiped by workers using towels saturated with conversion chemicals such as Alodine wipes from Henkel Corporation and dried. The conversion coated-frame is now ready for application of adhesive and assembly into a composite structure. This method does not require the conversion coating tanks and related equipment. However, manually wiping the entire frame requires substantial effort and time and has the risk that workers can miss some areas of the frame.

It is desirable to provide liquid, one component, moisture curable polyurethane adhesive compositions having increased adhesion strength to one or more composite components. It is desirable to provide a liquid, one component, moisture curable polyurethane adhesive compositions which have increased adhesion strength without requiring conversion coatings on the metallic components. It is desirable to provide a liquid, one component, moisture curable polyurethane adhesive compositions that would substantially retain the increased strength during and after exposure to water. It is desirable to provide a liquid, one component, moisture curable polyurethane adhesive compositions that should be useful with existing processes and equipment and would not require heating to a molten state for use.

### SUMMARY OF THE DISCLOSURE

This section provides a general summary of the disclosure and is not a comprehensive disclosure of its full scope or all features, aspects or objectives.

In one embodiment, the disclosure is a liquid, one component, moisture curable polyurethane adhesive composition comprising an isocyanate functional prepolymer; a silicone oligomer; and optionally other components and additives.

In one embodiment the isocyanate functional prepolymer is the reaction products of at least one polyol and equivalents excess of at least one organic polyisocyanate.

In one embodiment the adhesive compositions herein are free of silane modified polymers (SMP).

In one embodiment the disclosure comprises cured reaction products of the disclosed liquid, one component, reactive polyurethane adhesive composition.

In at least one embodiment the at least one organic polyisocyanate comprises polymeric MDI or a mixture of polymeric MDI and MDI isomers.

In at least one embodiment the disclosure is a process of bonding a skin or panel to a metal frame to form a reinforced composite structure, comprising providing a liquid, one component, moisture curable polyurethane adhesive composition as described in any of the embodiments; disposing the liquid, one component, moisture curable polyurethane adhesive composition on a surface of at least one of the panel or the metal frame; disposing a surface of the panel in contact with the disposed adhesive and adjacent to the surface of the metal frame; and exposing the disposed adhesive to conditions that will initiate curing. In one preferred embodiment the metal frame is aluminum and has not been treated with a conversion coating. In one preferred embodiment the metal frame is mill grade aluminum.

In one embodiment the disclosure comprises an article of manufacture including the disclosed liquid, one component, moisture curable polyurethane adhesive composition in cured or uncured form.

These and other features and advantages of this disclosure will become more apparent to those skilled in the art from the detailed description of a preferred embodiment. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

### DETAILED DESCRIPTION OF A PREFERRED EMBODIMENT

The singular forms “a”, “an” and “the” include plural referents unless the context clearly dictates otherwise.

Unless otherwise defined “about” or “approximately” used in connection with a numerical value refer to the numerical value±10%, preferably ±5% and more preferably ±1% or less.

Unless otherwise defined “%” refers to weight percent.

The term “essentially free” is intended to mean herein that the applicable group, compound, mixture or component constitutes less than 10 wt. %; typically, less than 1 wt. %, preferably less than 0.5 wt. %, more preferably less than 0.1 wt. %, and ideally no more than a trace amount based on the weight of the defined composition.

Unless otherwise defined “at least one” means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

Unless otherwise defined the terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Unless otherwise defined, “liquid” means the liquid, one component polyurethane adhesive composition in the uncured state and at room temperature is a generally incompressible fluid that retains a constant volume and will flow to conform to the shape of its container. Typically, the liquid, one component polyurethane adhesive composition will have a viscosity at room temperature of 500,000 cP or less, more typically 50,000 cP or less or preferably 20,000 or less.

As used herein, room temperature is 23° C. plus or minus about 5° C.

As used herein preferred and preferably refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mn can be calculated based on end group analysis (OH numbers according to DIN EN ISO 4629, free NCO content according to EN ISO 11909) or can be determined by gel permeation chromatography according to DIN 55672 with THE as the eluent. If not stated otherwise, all given molecular weights are those determined by gel permeation chromatography.

In one embodiment the liquid moisture curable polyurethane adhesive compositions comprise an isocyanate functional prepolymer, a silicone oligomer, preferably a tackifier and optional additives. In one embodiment the liquid moisture curable polyurethane adhesive compositions comprise an isocyanate functional prepolymer, a silane compound, a tackifier and optional additives. This embodiment is preferably free of a silicone oligomer.

The isocyanate (NCO) functional polyurethane prepolymer comprises reaction products formed from reaction of a mixture of one or more polyols and one or more polyisocyanates. There is an excess of equivalents of isocyanate to equivalents of OH so that the prepolymer is isocyanate (NCO) functional with NCO % from about 1% to about 28%. The disclosed liquid moisture curable polyurethane adhesive compositions cure in the presence of moisture either from the atmosphere or present on a substrate or as added by an operator during use. The cured reaction products form an irreversibly crosslinked polyurethane network with CO₂ given off as a byproduct of the curing process. The cured thermoset reaction products form structural bonds that have good heat resistance, good chemical resistance, good adhesion to metals without a conversion coating and can usually be applied at about room temperature.

Polyols useful to form the isocyanate functional polyurethane prepolymer include those polyols used for the production of polyurethanes, including, without limitation, polyether polyols, polyester polyols, polycarbonate polyols, polybutadiene polyols, polyacetal polyols, polyamide polyols, polyesteramide polyols, polyalkylene polyether polyols, polythioether polyols and mixtures thereof, preferably polyether polyols, polyester polyols, polycarbonate polyols and mixtures thereof. In one embodiment polyether polyols are preferred.

Useful polyester polyols include those that are obtainable by reacting, in a polycondensation reaction, dicarboxylic acids with polyols. The dicarboxylic acids may be aliphatic, cycloaliphatic or aromatic and/or their derivatives such as anhydrides, esters or acid chlorides. Specific examples of these are succinic acid, glutaric acid, adipic acid, pimelic acid, suberic acid, azelaic acid, sebacic acid, dodecandioic acid, phthalic acid, terephthalic acid, isophthalic acid, trimellitic acid, phthalic acid anhydride, tetrahydrophthalic acid anhydride, glutaric acid anhydride, maleic acid, maleic acid anhydride, fumaric acid, dimeric fatty acid, dodecane dioic acid and dimethyl terephthalate. Examples of suitable polyols are monoethylene glycol, 1,2-propanediol, 1,3-propanediol, 1,4-butanediol, 3-methylpentane-1,5-diol, neopentyl glycol (2,2-dimethyl-1,3-propanediol), 1,6-hexanediol, 1,8-otaneglycol cyclohexanedimethanol, 2-methylpropane-1,3-diol, diethyleneglycol, triethyleneglycol, tetraethyleneglycol, polyethyleneglycol, dipropyleneglycol, tripropyleneglycol, tetrapropyleneglycol, polypropyleneglycol, dibutyleneglycol, tributyleneglycol, tetrabutyleneglycol and polybutyleneglycol. Alternatively, they may be obtained by ring-opening polymerization of cyclic esters, preferably caprolactone. Polyester polyols are commercially available, for example Piothane polyols available from Panolam Industries International and Dynacoll polyols available from Evonik. Other suppliers include Stepan, COIM and Lanxess. The polyester polyol may comprise a mixture of different polyester polyols.

Useful polyether polyols that can be used include linear and branched polyethers having hydroxyl groups. Examples of the polyether polyol may include a polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct of at least one compound selected from the group ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl) propane, triethanolamine, triisopropanolamine, ethylenediamine and ethanolamine. Most preferably the polyether polyol comprises polypropylene glycol. Preferably the polyether polyol has a number average molecular weight of from 500 to 6,000 Daltons with a more preferred range of 1,000 to 4,000 Daltons. The polyether polyol may comprise a mixture of different polyether polyols.

Useful polycarbonate polyols can be obtained by reaction of carbon acid derivatives, e.g., diphenyl carbonate, dimethyl carbonate or phosgene with diols. Suitable examples of such diols include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-pro-panediol, 2,2,4-trimethyl pentanediol-1,3, dipropylene glycol, polypropylene glycols, dibutylene glycol, polybutylene glycols, bisphenol A, bisphenol F, tetrabromobisphenol A as well as lactone-modified diols. In some embodiments the diol component preferably contains 40 to 100 wt. % hexanediol, preferably 1,6-hexanediol and/or hexanediol derivatives. More preferably the diol component includes examples that in addition to terminal OH groups display ether or ester groups. The polycarbonate polyols should be substantially linear. However, they can optionally be slightly branched by the incorporation of polyfunctional components, in particular low-molecular polyols. Suitable examples include glycerol, trimethylol propane, hexanetriol-1,2,6, butanetriol-1,2,4, trimethylol propane, pentaerythritol, quinitol, mannitol, and sorbitol, methyl glycoside, 1,3,4,6-dianhydrohexites. The polycarbonate polyol may comprise a mixture of different polycarbonate polyols.

Useful polyols further comprise polyols that are hydroxy-functionalized polymers, for example hydroxy-functionalized siloxanes as well as polyols that comprise additional functional groups, such as vinyl or less preferably amino groups.

Polyisocyanates useful to form the isocyanate functional polyurethane prepolymer include single polyisocyanates and mixtures of polyisocyanates wherein the mixture has an average isocyanate functionality of 2 or more. Useful polyisocyanates include organic polyisocyanates such as, for example, alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like.

Organic polyisocyanates having a functionality of at least three can also be used. These are the trimerization and oligomerization products of the polyisocyanates already mentioned above, such as are obtainable, with the formation of isocyanurate rings, by appropriate reaction of polyisocyanates, preferably of diisocyanates. Where oligomerization products are used, those particularly suitable have a degree of oligomerization of on average from about 3 to about 5. Isocyanates suitable for the preparation of trimers are the diisocyanates already mentioned above, particular preference being given to the trimerization products of the isocyanates HDI, MDI or IPDI. Likewise suitable for use are the polymeric isocyanates, such as are obtained, for example, as a residue in the distillation bottoms from the distillation of diisocyanates. Suitable in this context is the polymeric MDI obtainable as a distillation residue from the distillation of MDI.

In one embodiment the liquid moisture curable polyurethane adhesive compositions can further include unreacted monomeric or other polyisocyanates.

In one embodiment the liquid moisture curable polyurethane adhesive compositions include a silicone oligomer of structure 1:

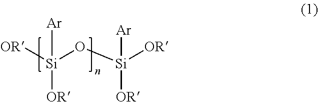

where each R′ is the same or different and is, independently from one another, selected from a hydrogen atom and hydrocarbon residues having 1 to 12 carbon atoms, preferably a methyl or ethyl group, more preferably a methyl group. Ar is selected from aryl groups, which may be linked or fused multiring aryl groups. Ar is preferably a phenyl group, n is an integer selected from 0-12, preferably 1-12. CAS Number 17938-09-9 (diphenyltetramethoxydisiloxane, n=1) is one example of a silicone oligomer of structure 1. CAS Number 2996-92-1 (phenyltrimethoxysiloxane, n=0) is one example of a silicone oligomer of structure 1. Silicone oligomers are available commercially or can be synthesized using the procedure provided in U.S. Pat. No. 10,800,881 to Despotopoulou et al, the contents of which are incorporated by reference.

In one embodiment the liquid moisture curable polyurethane adhesive compositions include a silane. Details of silanes can be found from “Handbook of Sealant Technology”, Edited by K. L. Mittal and A. Pizzi, CRC Press, 2009, Chapter 2, Organosilanes that can be used include amino-silane such as a secondary amino-silane. One attractive silane includes at least two silyl groups, with three methoxy groups bond to each of the silanes hindered secondary amino group or any combination thereof. An example of one such commercially available amino-silane is bis-(trimethoxysilylpropyl)-amine, such as Silquest A-1170. Other examples of useful organosilanes include silanes having a hydroxy functionality, a mercapto functionality, or both, such as 3-aminopropyltrimethoxysilane, 3-aminopropyltriethoxysilane, 3-aminopropyltrismethoxy-ethoxyethoxysilane, 3-aminopropy 1-methy 1-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyl-dimethoxysilane, (N-cyclohexylaminomethyl)methyldiethoxysilane, (N-cyclohexylaminomethyl)triethoxysilane, (N-phenylaminom-ethyl)methyldimethoxysilane, (N-phenylaminomethyl) tri-methoxysilane, N-ethyl-aminoisobutyltrimethoxysilane, 4-amino-3,3-dimethylbutyltrimethoxysilane, N-(n-butyl)-3-aminopropyltriethoxysilane, N-(n-butyl)-3-aminopropylalkoxydiethoxy-silane, bis(3-triethoxysilylpropyl)amine and any combination thereof.

Organosilanes are commercially available from many sources, for example Momentive Performance Materials (Silquest) and Evonik (Dynasylan). Some useful examples include Silquest A-Link 15 (N-ethyl-3-trimethoxysilyl-2-methylpropanamine), Silquest A-Link 35 (Gamma-isocyanatopropyltrimethoxysilane), Silquest A174NT (Gamma-methacryloxypropyltrimethoxysilane), Silquest A187 (Gamma-glycidoxypropyltrimethoxysilane), Silquest A189 (Gamma-mercaptopropyltrimethoxysilane), Silquest A 597 (Tris(3-(trimethoxysilyl) propyl) isocyanurate), Silquest A1110 (Gamma-aminopropyltrimethoxysilane), Silquest A1170 (Bis(trimethoxysilylpropyl)amine), Dynasylan 1189 (N-butyl-3-aminopropyltrimethoxysilane), Silquest A1289 (bis-(triethoxysilylpropyletrasulfide), and Silquest Y9669 (N-phenyl-gamma-aminopropyltrimethoxysilane).

The adhesive composition can optionally include a tackifier. Useful tackifiers include, for example, the natural and petroleum-derived materials and combinations thereof as described in: C. W. Paul, “Hot Melt Adhesives”, in Adhesion Science and Engineering-2, Surfaces, Chemistry and Applications, M. Chaudhury and A. V. Pocius eds., Elsevier, New York, 2002, p. 718. Such useful tackifiers include rosin esters, aromatic hydrocarbon resins, aliphatic-modified aromatic hydrocarbon resins, phenolic-modified terpene resins, phenolic-modified aromatic resins and pure monomer resins.

The adhesive composition can optionally include one or more additives. Common adhesive additives include, for example, catalyst, adhesion promoter, polyisocyanates, for example Desmodur N-series from Covestro, colorant, UV pigment, filler, solvent, oil, MA-SCA acid, plasticizer, moisture scavenger, rheology modifier, flame retardant, defoamer, and combinations thereof. Alternatively, the compositions can be essentially free or free of any or all of these additives.

The disclosed adhesive compositions can optionally include catalyst. The optional catalyst can be any moisture curing catalyst for isocyanates, for example 2,2′-dimorpholinodiethylether, triethylenediamine, dibutyltin dilaurate and stannous octoate. While metal-based catalysts can work they are preferably not used. Organic catalysts are preferred such as the tertiary amine catalyst 2,2′-dimorpholinodiethylether (DMDEE).

The disclosed adhesive compositions can optionally include adhesion promoter. Adhesion promoters include aminosilanes as disclosed above.

The disclosed adhesive compositions can optionally include one or more different types of filler. If filler is used, 1 wt. %, 5 wt. %, 20 wt. %, or up to about 60 wt. % filler can be used in the adhesive composition. Fillers that can be used include inorganic fillers such as calcium carbonate, powdered limestone, silica such as precipitated silica and/or pyrogenic silica, zeolites, bentonites, magnesium carbonate, kieselguhr, alumina, clay, titanium oxide, iron oxide, zinc oxide, sand, quartz, flint, mica, powdered glass, ground minerals; organic fillers such as carbon black, graphite, wood fibers, wood flour, sawdust, cellulose, cotton, pulp, wood chips, chopped straw, chaff, ground walnut shells; short-cut fibers such as glass fibers, glass filament, polyacrylonitrile fibers, carbon fibers, Kevlar fibers, polyethylene fibers; and hollow spheres with a mineral shell or a plastic shell such as hollow glass spheres commercially available as Glass Bubbles® and plastic hollow spheres commercially available as Expancel® or Dualite®. These hollow sphere fillers are composed of inorganic or organic substances, each with a diameter of 1 mm or less, preferably of 500 μm or less. In one embodiment calcium carbonate can be used as a filler as this can be considered a sustainable, renewable, non-fossil fuel filler.

The disclosed adhesive compositions can optionally include organic solvents. Preferably, the adhesive composition according to the present disclosure is essentially free from any organic solvents in any stage of the formulation. Since the adhesive composition contains moisture reactive isocyanate moieties water must be excluded during manufacture and storage of the adhesive composition.

The disclosed adhesive compositions can optionally include liquid oils such as mineral oils, paraffin oils, and aromatic oils. Many liquid paraffinic oils and aromatic oils can be used such as n-paraffinic oils, iso-paraffinic oils and other branched paraffins, cycloparaffins (naphthenes), condensed cycloparaffins (including steranes and hopanes), and others with alkyl side chains on ring systems. The paraffinic oil may be a 100% n-alkanes based paraffinic oil, with a molecular formula CH₃[CH₂]ₙCH₃. This paraffinic oil is also called liquid paraffin, white mineral oil or liquid petrolatum. Commercially available examples of the paraffinic oil include those under the trade name Citation™ NF grade from Avatar Corporation. Aromatic oils suitable for use herein include oils which contain at least one ring that has a conjugated pi-electron system with (4n+2)pi electrons, where n is an integer such as 0, 1, or 2. Such aromatic oils include those aromatic hydrocarbons containing benzene systems, condensed aromatic systems, condensed aromatic cycloalkyl systems, and others with alkyl side chains on ring systems. An example of an aromatic oil useful herein is a complex mixture of 100% aromatic hydrocarbons, commercially available under the trade name Viplex®, and Vycel® from Crowley Chemical Company, and Shellflex® from Shell Company. More information generally about liquid paraffinic oils and aromatic oils can be found in “The Chemistry and Technology of Petroleum”, 4th Edition by James Speight, CRC Press, the disclosure of which is expressly incorporated herein by reference.

The adhesive can optionally include an MA-SCA acid. An MA-SCA acid is a subset of multibasic acids having acidic groups connected eventually to a single central atom. Examples of MA-SCA acids include sulfuric acid, phosphonic acid, phosphoric acid, diphosphoric acid (pyrophosphoric acid).

In one embodiment the liquid moisture curable polyurethane adhesive compositions comprise a mixture including:

| | range | narrower range |
|---|---|---|
| | (wt. %) | (wt. %) |
| isocyanate functional prepolymer | 20-99.9 | 35-99.5 |
| silicone oligomer | 0.05-5 | 0.1-3 |
| silane | 0-5 | 0.05-3 |
| tackifier | 0-35 | 0-30 |
| additives | 0-75 | 0-50 |

In another embodiment the liquid moisture curable polyurethane adhesive compositions comprise a mixture including:

| | range | narrower range |
|---|---|---|
| | (wt. %) | (wt. %) |
| isocyanate functional prepolymer | 20-99.9 | 35-99.5 |
| silane | 0.1-5 | 0.1-3 |
| tackifier | 1-35 | 1-30 |
| additives | 0-75 | 0-50 |

The disclosed polyurethane adhesive composition preferably comprises a single component composition. Two-component polyurethane adhesive compositions, wherein the components are stored separately and mixing of the two components starts a cure reaction, are formulated differently from one component polyurethane adhesives. Two component polyurethane compositions when mixed and cured also provide different reaction products than a one component polyurethane composition. Two component polyurethane adhesives require special handling and equipment and are not interchangeable with one component polyurethane adhesives for every application. Unlike liquid, one component, moisture curable polyurethane adhesives, a two component polyurethane adhesive requires accurate mixing to a specific ratio of the two components.

In a less preferred embodiment for applications other than reinforced composite panel manufacture, the polyurethane adhesive composition according to the present disclosure can comprise a two component composition. In such a less preferred two component composition one component comprises the isocyanate functional polyurethane pre-polymer reaction products and other typical ingredients and the separate second component comprises an isocyanate reactive material such as a polyol and other typical ingredients to react with the first component.

No particular method is required for preparation of the composition and standard practices can be used. In one embodiment the adhesive composition can be prepared by adding the polyol to a reaction vessel. The reaction vessel is heated and placed under vacuum or inert gas atmosphere to remove traces of moisture. If used, catalyst can be added before or during heating. Once the reaction vessel is generally moisture free the polyisocyanate is added with mixing and allowed to react with the polyol. If used, additives can be added before the polyisocyanate if they will not interfere with the polyisocyanate-polyol reaction or can be added after the reaction is complete. The final adhesive composition is transferred to a moisture proof container and sealed to exclude moisture.

The disclosed liquid moisture curable polyurethane adhesive compositions are particularly suited for use as an adhesive in reinforced composite structures. One example is the large reinforced composite panels used in making recreational vehicles. Such reinforced composite panels typically include one or two panels or “skins” laminated to opposing sides of a reinforcing metal frame. The skins can comprise, for example, wood or wood products, plastics, fiber reinforced plastics (FRP), metals or metal foils, high pressure laminate (HPL) skins, or other materials. Typically the exterior skin is plastic or plastic composite to resist weathering. If an internal skin is desired, it is typically wood or laminated wood such as Lauan plywood. The frame typically comprises a plurality of tubular metal sections that are welded together to form a structural frame. Generally, the tubular metal sections have a quadrilateral cross-sectional shape with bonding surfaces defined on opposing sides of the shape. Structural aluminum pieces are used in recreational vehicles almost exclusively to lessen weight of the frame and vehicle. Materials such as expanded polystyrene (EPS) foam sheet can be disposed between the skins in space not taken by the frame. A panel lamination process includes: disposing a one component, liquid adhesive on some of the surfaces to be laminated; optionally misting the adhesive with water to accelerate curing; placing the skin or skins in contact with adhesive disposed on the frame surfaces; placing the assembled parts in a press to apply pressure and possibly heat as well to the assembled parts and maintain the parts in position until substantially cured; and routing or stocking of the parts from the press after the initial cure of the adhesive. For multiple layers this process is repeated until the final lamination stack has been assembled. Then the final lamination stack is moved to a press station wherein the press applies pressure to the lamination stack and the adhesive can develop its initial strength through an initial cure, i.e., develops green strength, as is known in the industry. Once sufficient initial or green strength is developed the lamination stack is moved out of the press and routed to the next station. The disclosed liquid, moisture curable, polyurethane adhesive compositions provide surprisingly enhanced bond strength to the aluminum frame compared to conventional adhesives.

For reinforced composite panels used in vehicles it is desired to have a % adhesion of at least about 30%, preferably at least about 50%, more preferably at least about 70% and most preferably 90%. An adhesion % of 100% would be ideal as it denotes the substrate fails before the adhesive bond. While some of these adhesion strengths can be achieved with conventional adhesives in combination with anodized or conversion coated aluminum frame members it has not been possible to consistently achieve even the 30% adhesion strength using conventional adhesives with mill grade aluminum frame members, e.g. aluminum frame members as received from a mill with no cleaning and no conversion coating or anodizing.

### Experimental Data

Viscosity of the products, in centipoise (cP), was measured at 25° C. using a Brookfield viscometer model DV-I Prime with a number 27 spindle.

NCO % was monitored using a Brinkman Metrohm automatic titrator and known preset procedure.

% adhesion was evaluated by applying the test composition to an untreated piece of mill grade, hollow rectangular aluminum tubing at an effective coating weight of 10 to 12 grams per square foot (gsf). The untreated samples were mill grade aluminum used as received, they were not cleaned or anodized or conversion coated before testing. The applied composition was misted with water. A piece of Lauan plywood (approximately 3 mm thick) was disposed over the applied adhesive and vacuum bag pressed onto the adhesive and tubing for 1 hour. The laminate was allowed to cure for one week at room temperature and ambient humidity (about 50% RH) conditions. After curing, the cured laminate was soaked in 40° C. water for 0.5 hours and dried for 1 hour at ambient temperature and humidity conditions. Adhesion of Lauan plywood to aluminum was evaluated by attempting to pry the plywood off of the tubing using a spatula. The percentage of Lauan plywood failure was visually assessed based on the amount of wood remaining bonded to the aluminum e.g. 90% adhesion means 90% of the wood remains bonded (a good result) while 10% adhesion means 10% of the wood remains bonded (a failing result). The results were recorded. The uncertainty range for the % adhesion is about + or −5%.

The compounds used in the experimental formulations are as follows. PPG1000, a polypropylene glycol, number average molecular weight of about 1,000 from Covestro. PPG2000, a polypropylene glycol, number average molecular weight of about 2,000 from Covestro. Mondur MRS2, a polymeric diphenylmethane diisocyanate (pMDI) functionality=2.2 from Covestro. Foralyn 5020F, a rosin based tackifier from Eastman Chemical. Sylvalite 10 L, a rosin based tackifier from Kraton. Kristalex 3100, a hydrocarbon based tackifier from Eastman Chemical. Kristalex 3085, a hydrocarbon based tackifier from Eastman Chemical. Diphenyltetramethoxydisiloxane *1,3-, Silquest A link 35, an isocyanate functional, trimethoxy silyl compound from Momentive Performance Materials. Silquest A-1110, identified as gamma-aminopropyltrimethoxysilane by Momentive Performance Materials. Phenyltrimethoxysilane, DMDEE, the catalyst, 2,2′-dimorpholinildiethylether, from Huntsman Corporation

### Silicone Oligomers.

The silicone oligomers are commercially available. Alternatively, the silicone oligomers can be synthesized.

Synthesis of Diphenyltetramethoxydisiloxane (n=1 in Formula 1)

Phenyltrimethoxysilane (195.2 g) can be placed in a 3 neck round bottom flask (0.5 L) equipped with a magnetic stirring bar a thermometer and a dropping funnel. 1 N Hydrochloric acid (8.8 g with a molar ratio of water:methoxy 6:1) can be added dropwise to the silane over a period of 7 h, whereby the temperature of the mixture is not allowed to exceed 40° C. The mixture can be left stirring for 10 h after which the reaction was stopped and the mixture stored at 25° C. for at least one day prior to distillation. Purification of the reaction mixture occurred via vacuum distillation. At a vacuum of 1 mbar two fractions were isolated. The first fraction came at 130° C. and contained unreacted phenyltrimethoxysilane. The second fraction was isolated at 230° C. and contained the desired product 1,2-diphenyltetramethoxydisiloxane (36% yield)

### Comparative Sample A

270.0 parts of PPG 2000, 270.0 parts of PPG 1000, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. The reaction product was then transferred to a moisture proof container and sealed immediately for future test.

### Comparative Sample B

240.0 parts of PPG 2000, 240.0 parts of PPG 1000, 60.0 parts of Foralyn 5020F, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. The reaction product was then transferred to a moisture proof container and sealed immediately for future test.

### Sample 1

270.0 parts of PPG 2000, 270.0 parts of PPG 1000, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of 1,3-diphenyltetramethoxydisiloxane was blended in and stirred for 15 minutes. The reaction product was then transferred to a moisture proof container and sealed immediately for future test.

### Sample 2

270.0 parts of PPG 2000, 270.0 parts of PPG 1000, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80 C. Then, the temperature was lowered to 60 C, and 4.0 parts of Phenyltrimethoxysilane was blended in and stirred for 15 minutes. The reaction product was then transferred to a moisture proof container and sealed immediately for future test.

### Comparative Sample C

270.0 parts of PPG 2000, 270.0 parts of PPG 1000, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of A link 35 was blended in and stirred for 15 minutes. The reaction product was then transferred to a moisture proof container and sealed immediately for future test.

### Comparative Sample D

270.0 parts of PPG 2000, 270.0 parts of PPG 1000, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of A1110 was blended in and stirred for 15 minutes. The reaction product was then transferred to a moisture proof container and sealed immediately for future test.

### Sample 3

240.0 parts of PPG 2000, 240.0 parts of PPG 1000, 60.0 parts of Foralyn 5020F, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of 1,3-diphenyltetramethoxydisiloxane was blended in and stirred for 15 minutes. The reaction product was then transferred to a moisture proof container and sealed immediately for future test.

### Sample 4

240.0 parts of PPG 2000, 240.0 parts of PPG 1000, 60.0 parts of Foralyn 5020F, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of Phenyltrimethoxysilane was blended in and stirred for 15 minutes. The reaction product was then transferred to a moisture proof container and sealed immediately for future test.

### Sample 5

240.0 parts of PPG 2000, 240.0 parts of PPG 1000, 60.0 parts of Foralyn 5020F, and 4.0 parts of DMDEE were introduced into a heatable stirred tank reactor with a nitrogen connection and heated up to 80° C. under nitrogen. Then, 460.0 parts of Mondur MRS2 were added, and the contents of the reactor were stirred for 2.0 hours under nitrogen at 80° C. Then, the temperature was lowered to 60° C., and 4.0 parts of A link 35 was blended in and stirred for 15 minutes. The reaction product was then transferred to a moisture proof container and sealed immediately for future test.

### Sample 6

240.0 parts of PPG 2000, 240.0 parts of PPG 1000, 60.0 parts of Foralyn 5020F, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of A1110 was blended in and stirred for 15 minutes. The reaction product was then transferred to a moisture proof container and sealed immediately for future test.

### Sample 7

240.0 parts of PPG 2000, 240.0 parts of PPG 1000, 60.0 parts of Sylvalite 10 L, and 4.0 parts of DMDEE were introduced into a heatable stirred tank reactor with a nitrogen connection and heated up to 80° C. under nitrogen atmosphere. Then, 460.0 parts of Mondur MRS2 were added, and the contents of the reactor were stirred for 2.0 hours under nitrogen at 80° C. Then, the temperature was lowered to 60° C., and 4.0 parts of 1,3-diphenyltetramethoxydisiloxane was blended in and stirred for 15 minutes. The reaction product was then transferred to a moisture proof container and sealed immediately for future test.

### Sample 8

240.0 parts of PPG 2000, 240.0 parts of PPG 1000, and 60.0 parts of Kristalex 3100, were introduced into a heatable stirred tank reactor with a nitrogen connection and heated up to 100° C. under nitrogen atmosphere. After the solid tackifier was dissolved, the temperature was lowered to 80° C. Then, 460.0 parts of Mondur MRS2 and 4.0 parts of DMDEE were added, and the contents of the reactor were stirred for 2.0 hours under nitrogen at 80° C. Then, the temperature was lowered to 60° C., and 4.0 parts of 1,3-diphenyltetramethoxydisiloxane was blended in and stirred for 15 minutes. The reaction product was then transferred to a moisture proof container and sealed immediately for future test.

### Comparative Sample E

240.0 parts of PPG 2000, 240.0 parts of PPG 1000, and 60.0 parts of Kristalex 3100 were introduced into a heatable stirred tank reactor with a nitrogen connection and heated up to 100° C. under nitrogen atmosphere. After the solid tackifier was dissolved, the temperature was lowered to 80° C. Then, 460.0 parts of Mondur MRS2 and 4.0 parts of DMDEE were added, and the contents of the reactor were stirred for 2.0 hours under nitrogen at 80° C. The reaction product was then transferred to a moisture proof container and sealed immediately for future test.

### Sample 9

240.0 parts of PPG 2000, 240.0 parts of PPG 1000, and 60.0 parts of Kristalex 3085 were introduced into a heatable stirred tank reactor with a nitrogen connection and heated up to 100° C. under nitrogen atmosphere. After the solid tackifier was dissolved, the temperature was lowered to 80° C. Then, 460.0 parts of Mondur MRS2 and 4.0 parts of DMDEE were added, and the contents of the reactor were stirred for 2.0 hours under nitrogen at 80° C. Then, the temperature was lowered to 60° C., and 4.0 parts of A link 35 was blended in and stirred for 15 minutes. The reaction product was then transferred to a moisture proof container and sealed immediately for future test.

The compositions were evaluated for adhesion. Formulations and results are provided in the following TABLE. All amounts are in parts by weight.

| | | Viscosity (cp) | |
|---|---|---|---|
| | | of initial/final¹ | % |
| Sample | Composition | product | Adhesion |
| A | PPG1000; PPG2000; DMDEE; | 11300/13200 | 5 |
| | MRS2 | | |
| B | PPG1000; PPG2000; Foralyn | 8400 | 5 |
| | 5020F; DMDEE; MRS2 | | |
| 1 | PPG1000; PPG2000; DMDEE; | 11550/13900 | 45 |
| | MRS2; 1,3-diphenyltetramethoxy- | | |
| | disiloxane | | |
| 2 | PPG1000; PPG2000; DMDEE; | 11200 | 35 |
| | MRS2; Phenyltrimethoxysilane | | |
| C | PPG1000; PPG2000; DMDEE; | 11250 | 5 |
| | MRS2; A link 35 | | |
| D | PPG1000; PPG2000; DMDEE; | 13600/16235 | 5 |
| | MRS2; A1110 | | |
| 3 | PPG1000; PPG2000; Foralyn | 8575/10250 | 95 |
| | 5020F; DMDEE; MRS2; 1,3- | | |
| | diphenyltetramethoxydisiloxane | | |
| 4 | PPG1000; PPG2000; Foralyn | 8525 | 95 |
| | 5020F; DMDEE; MRS2; Phenyltri- | | |
| | methoxysilane | | |
| 5 | PPG1000; PPG2000; Foralyn | 8250 | 95 |
| | 5020F; DMDEE; MRS2; A link 35 | | |
| 6 | PPG1000; PPG2000; Foralyn | 9700 | 75 |
| | 5020F; DMDEE; MRS2; A1110 | | |
| 7 | PPG1000;PPG2000; Sylvalite 10L, | 9500 | 95 |
| | DMDEE; MRS2; 1,3- | | |
| | diphenyltetramethoxydisiloxane | | |
| 8 | PPG100; PPG2000; Kristalex | 12500 | 95 |
| | 3100; DMDEE; MRS2; 1,3- | | |
| | diphenyltetramethoxydisiloxane | | |
| E | PPG1000; PPG2000; Kristalex | 12100 | 15 |
| | 3100; DMDEE; MRS2 | | |
| 9 | PPG1000; PPG2000; Kristalex | 11800 | 95 |
| | 3085, DMDEE, MRS2; A link 35 | | |

¹The first or only number is the viscosity at 25° C. when the sample was made. The number after slash is the viscosity after baking the sealed samples for 24 hours at 90° C.

Sample A shows a conventional liquid, moisture curable polyurethane adhesive has poor adhesion to untreated aluminum.

Sample B shows adding a liquid tackifier to the conventional liquid, moisture curable polyurethane adhesive of Sample A does not improve the poor adhesion to untreated aluminum.

Sample 1 and Sample 2 show that adding a silicone oligomer to the conventional liquid, moisture curable polyurethane adhesive of Sample A significantly improves adhesion to untreated aluminum.

Sample 3 and Sample 4 show that adding both a silicone oligomer and a liquid tackifier to the conventional liquid, moisture curable polyurethane adhesive of Sample A significantly improves adhesion to untreated aluminum. Surprisingly, the improvement in adhesion for Sample 3 and Sample 4 is greater than the sum of adhesion improvements provided by the liquid tackifier and silicone oligomer separately.

Sample C shows that adding a silane (A link 35) to the conventional liquid, moisture curable polyurethane adhesive of Sample A does not improve the poor adhesion to untreated aluminum.

Sample 5 shows that adding both a tackifier and a silane to the conventional liquid, moisture curable polyurethane adhesive of Sample A significantly improves the adhesion to untreated aluminum. Surprisingly, the improvement in adhesion for Sample 5 is greater than the sum of adhesion improvements provided by the liquid tackifier and silane separately.

Sample D shows that adding a silane adhesion promoter (Silquest A-1110) to the conventional liquid, moisture curable polyurethane adhesive of Sample A does not improve the poor adhesion to untreated aluminum. Sample 6 shows that adding both a tackifier and a silane to the conventional liquid, moisture curable polyurethane adhesive of Sample A surprisingly improves the adhesion to untreated aluminum. Surprisingly, the improvement in adhesion for Sample 6 is greater than the sum of adhesion improvements provided by the liquid tackifier and silane separately.

Sample 9 shows that adding both a silane and a solid tackifier (Kristalex 3085) to the conventional liquid, moisture curable polyurethane adhesive of Sample A significantly improves adhesion to untreated aluminum.

Sample 7 shows that adding both a silicone oligomer and a liquid tackifier (Sylvalite 10 L) to the conventional liquid, moisture curable polyurethane adhesive of Sample A significantly improves adhesion to untreated aluminum.

Sample E shows adding a solid tackifier (Kristalex 3100) to the conventional liquid, moisture curable polyurethane adhesive of Sample A does not improve the poor adhesion to untreated Aluminum.

Sample 8 shows that adding both a silicone oligomer and a solid tackifier (Kristalex 3100) to the conventional liquid, moisture curable polyurethane adhesive of Sample A significantly improves adhesion to untreated aluminum. Surprisingly, the improvement in adhesion for Sample 8 is greater than the sum of adhesion improvements provided by the solid tackifier and silane separately.

A liquid, one component, moisture curable polyurethane adhesive composition comprising an isocyanate functional prepolymer and a silicone oligomer shows improved adhesion to untreated Aluminum compared to the same adhesive composition without the silicone oligomer. Furthermore, if the liquid, one component, moisture curable polyurethane adhesive composition comprises both the silicone oligomer and a tackifier adhesion to untreated Aluminum is improved over the components separately. Such a synergy is surprising and not expected.

The silane case is somewhat different. Adding silanes to the isocyanate functional prepolymer does not increase adhesion to untreated Aluminum. This is surprising as the silanes used are known to be adhesion promoters. We also see that adding a tackifier in the absence of silane compounds to the isocyanate functional prepolymer does not improve adhesion to untreated Aluminum. However, if a liquid, one component, moisture curable polyurethane adhesive composition is formulated to contain both a silane compound and a tackifier, adhesion to Aluminum is improved substantially. Such a strong synergy is surprising and not expected.

We claim:

1. A liquid, one component, reactive polyurethane adhesive, comprising:
an isocyanate functional prepolymer that is a reaction product of a mixture including at least one polyisocyanate and at least one polyol;
one of
a) a silane and a tackifier; or
b) a silicone oligomer of structure 1: 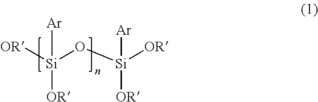
wherein each R′ is the same or different and is, independently from one another, selected from a hydrogen atom or a hydrocarbon residue having 1 to 12 carbon atoms;
n is an integer selected from 0-12; and
optionally, a tackifier;
wherein the isocyanate functional prepolymer is free of Si atoms; and optionally one or more additives.

2. The liquid, one component, reactive polyurethane adhesive of claim 1, wherein b) the silicone oligomer of structure 1 is present, wherein each R′ is the same or different and is, independently from one another, selected from a methyl or ethyl group, Ar is a phenyl group; and n is an integer selected from 1-12; and the adhesive comprises at least 0.5 wt. % by weight of the one or more additives.

3. The liquid, one component, reactive polyurethane adhesive of claim 1, wherein the polyol in the mixture comprises at least one polyether polyol.

4. The liquid, one component, reactive polyurethane adhesive of claim 1, further comprising up to 60 wt. % of an inorganic filler.

5. The liquid, one component, reactive polyurethane adhesive of claim 1, wherein cured reaction products of the adhesive have a % adhesion of at least 30.

6. The liquid, one component, reactive polyurethane adhesive of claim 1, further comprising a tackifier.

7. The liquid, one component, reactive polyurethane adhesive of claim 1, being free of either the a) silane or the b) silicone oligomer of structure 1.

8. A method of making a bonded reinforced composite structure, comprising:
providing an aluminum frame having a first bonding surface;
providing a first panel having a bonding surface;
providing a liquid, one component, reactive polyurethane adhesive, comprising:
an isocyanate functional prepolymer that is a reaction product of a mixture including at least one polyisocyanate and at least one polyol;
one of
a) a silane and a tackifier; or
b) a silicone oligomer of structure 1: 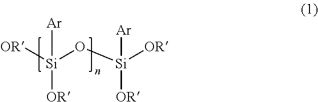
wherein each R′ is the same or different and is, independently from one another, selected from a hydrogen atom or a hydrocarbon residue having 1 to 12 carbon atoms;
wherein the isocyanate functional prepolymer is free of Si atoms; and
optionally one or more additives;
applying the liquid adhesive on at least one bonding surface;
disposing the first panel bonding surface in contact with the disposed adhesive and frame bonding surface to form a composite structure; and
curing the adhesive to bond the first panel to the metal frame.

9. The method of claim 8, wherein:
the aluminum frame has a quadrilateral cross section and a second bonding surface opposing the first bonding surface; and comprising:
providing a second panel having a bonding surface;
applying the adhesive on at least one of the frame second bonding surface or the second panel bonding surface;
disposing the second panel bonding surface in contact with the disposed adhesive and frame second bonding surface; and
curing the adhesive to bond the second panel to the metal frame.

10. The method of claim 8, wherein at least one aluminum bonding surface is mill grade with no cleaning.

11. The method of claim 8, wherein at least one aluminum bonding surface has no surface conversion coating and/or anodizing.

12. The method of claim 8, wherein at least one aluminum bonding surface is conversion coated.

13. The method of claim 8, wherein the first panel comprises a cured polymer and/or plywood.

14. The method of claim 8, wherein the composite structure is free of mechanical fasteners to hold the first panel to the frame.

15. The method of claim 8, further comprising disposing insulation in a void area defined by the frame and first panel bonding surface.

16. The method of claim 8, further comprising the step of exposing the applied adhesive to water before the step of disposing the first panel bonding surface in contact with the disposed adhesive and frame bonding surface.

17. The method of claim 8, comprising placing the composite structure in a press, wherein the step of curing is at least partially done while the composite structure is in the press.

18. A composite panel comprising the one component, reactive polyurethane adhesive of claim 1 and an aluminum substrate.
